(19) United States
(12) Patent Application Publication
(10) Pub. No.: US 2019/0283643 A1
(43) Pub. Date: Sep. 19, 2019

(54) ELECTRICALLY ADJUSTABLE LUMBAR SUPPORT OF A MOTOR VEHICLE SEAT

(71) Applicant: FORD GLOBAL TECHNOLOGIES, LLC, Dearborn, MI (US)

(72) Inventors: Michael Gerharz, Frechen (DE); Marco Friese, Neuss (DE); Clemens J. Marek, Frechen (DE); Julia Stallmach, Koln (DE)

(21) Appl. No.: 16/357,383

(22) Filed: Mar. 19, 2019

(30) Foreign Application Priority Data
Mar. 19, 2018 (DE) 102018204140.7

(51) Int. Cl. B60N 2/90; B60N 2/02; B60N 2/66; A61H 7/00

(52) U.S. Cl. CPC B60N 2/976; B60N 2/0232; B60N 2/0244; B60N 2/666; A61H 2201/0192; A61H 2201/0149; A61H 2201/5025; A61H 2203/0431; A61H 7/00

(57) ABSTRACT

An operator control unit controls an electrically adjustable lumbar support of a motor vehicle seat, where the lumbar support is provided for performing a massage function. A four-way button for setting an inoperative position of the lumbar support and a three-way switching element for selecting a predetermined value for a massage parameter of the lumbar support are provided in the operator control unit.

### CROSS REFERENCE TO RELATED APPLICATIONS

The present application claim the benefit to German patent application DE 102018204140.7, filed Mar. 19, 2018, the contents of which are incorporated herein in their entirety.

### BACKGROUND OF THE INVENTION

The invention relates to a motor vehicle seat and an operator control unit for controlling an electrically adjustable lumbar support of a motor vehicle seat, where the lumbar support is provided for performing a massage function.

In the field of automotive engineering, it is known to use electric drives in order to improve operator control convenience for users when individually adjusting an adjustable vehicle seat or the moving parts thereof. In this case, the electric drives are actuated by operator control elements such as switches or buttons, numerous solutions for the type and arrangement of which have been disclosed in the prior art.

A common solution involves using electric drives for straightening and reclining a backrest, for sliding an entire vehicle seat forward and backward and for adjusting the inclination and/or height of a seat base.

For example, U.S. Pat. No. 8,183,477 B2 describes a switching apparatus for adjusting an electrically adjustable seat in a vehicle, which switching apparatus is constructed such that it mechanically limits the simultaneous performance of three functions, without using an additional securing arrangement or an end switch. The switching apparatus can comprise a body, a plurality of switches which are installed on the body and include a first switch, which is operated in the horizontal direction, and a second switch which is at a distance from the first switch and is operated in the vertical direction. Furthermore, the switching apparatus can include a guide fork, the first end section of said guide fork being integrally coupled with the first switch and the second end section of said guide fork being arranged around the second switch and being selectively coupled with the second switch depending on a horizontal movement of the first switch. In this case, the second switch can move in the vertical direction while the first switch is in a neutral position, and the guide fork is limited by the second end section and therefore cannot move while the first switch is outside the neutral position. The second end section of the guide fork limits the second switch while the second switch is outside a neutral position, as a result of which the movement of the first switch is limited. The switching apparatus is provided with two pushbuttons which are fitted on a side face on the outside of the seat beneath a seat cushion of the seat and are at a distance from one another. The first pushbutton is used for reclining a backrest, and the second pushbutton is used for sliding the seat forward and backward and for adjusting the inclination/the height of the seat cushion.

Furthermore, U.S. Pat. No. 4,326,690 A proposes an adjusting apparatus of a motor vehicle seat. The adjustable motor vehicle seat has independent front- and rear-edge adjusting and supporting means in order to provide vertical adjustment of a seat between raised and lowered positions and inclination adjustment of the seat between an untilted position and a tilted-forward position, while backward-tilting of the seat is prevented. The adjusting and supporting means preferably comprise separate motors, and the control elements are designed as rocker buttons.

An operator control switch panel is provided on the side of the front seat next to the position of the driver. The operator control switch panel includes a first control element and a second control element and also means for blocking an upward movement of the first control element and for blocking a downward movement of the second control element. A third control element which can be moved vertically in an elongate slot or horizontally in a further elongate slot is located between the first control element and the second control element. The first control element serves to effect only a downward movement of the front edge of the seat, while the second control element serves to effect only an upward movement of the rear edge of the seat. An upward movement/downward movement of the third control element effects simultaneous upward movement/downward movement of the front edge and the rear edge of the seat.

For the purpose of ergonomic back support, motor vehicles with increased driver comfort are often provided with a lumbar support (also: lordosis support) in a seat or in several of the seats of the motor vehicle. The lumbar support can be individually matched to the seat user by means of an electric drive.

One example of an electrically adjustable lordosis support in the front passenger seat is shown on the Internet site of American Sunroof Upholstery, (Dallas, Tex. (USA)) (available at http://asudallas.com/interior/lumbar-support/). The lordosis support is adjusted by a rocker button which is arranged on one side of the front passenger seat, below a seat surface.

The actuation of electric drives of moving parts of the vehicle seat additionally has to satisfy pre-specified safety requirements. For example, U.S. Pat. No. 4,809,180 A includes a seat control apparatus for adjusting a seat, which is fitted to a vehicle, by moving different parts which form the seat and include, in particular, an adjustable lordosis support, adjustable head support and adjustable lower limb support. The seat control apparatus has a switch, which is provided on the vehicle, for registering whether a door, which is adjacent to the seat, is open or closed, and has a control arrangement for generating control signals depending on a switching output of the switch. If an open state of the door is detected, a control operation for turning the seat is allowed. If the closed state of the door is registered, the control operation for turning the seat is prevented.

For the purpose of operating the large number of electrically adjustable seat parts, an operating switch and display unit of the seat control apparatus is arranged on a side section of the seat in the region of an armrest and in the field of vision of a seat user. Four operating switches are implemented in a keypad which can be selectively activated in respect of a forward movement, a backward movement, an increase region and a decrease region, wherein the increase region and decrease region relate to the electrically adjustable parts which are illustrated in the display unit and form the seat.

As a solution to arranging operator control elements for actuating moving vehicle seat parts, DE 199 26 519 B4 proposes an operator control apparatus for electrical seat adjustment of motor vehicle seats. The operator control element comprises individual switches which, together, correspond to the seat contour in miniaturized form and by way of which the individual elements of the vehicle seat can be electrically adjusted. The operator control element can be arranged on the vehicle seat, on the dashboard of the vehicle or in a door which is adjacent to the vehicle seat. A backrest switching element of the operator control element is of at least 2-part design for the purpose of separately adjusting at least two backrest parts of a seat, wherein the at least two parts of the backrest switching element can be operated separately. In this case, a first part of the at least two parts of the backrest switching element are configured for adjusting an upper backrest part of the at least two backrest parts, and a second part of the at least two parts of the backrest switching element is configured for adjusting a lower backrest part of the at least two backrest parts independently of the upper backrest part. Furthermore, a lordosis adjusting switch is provided, by way of which a lordosis support can be moved either upward or downward or can be extended to a greater or lesser extent. In this case, the lordosis adjusting switch has two intersecting switching parts, or in other words four switching directions.

DE 199 224 09 B4 further describes an operator control element for seat adjustment, in particular in motor vehicles, comprising seat adjusting switches either in the form of discrete switching or operator control elements, in the form of a miniaturized seat or on a screen, for adjusting a plurality of seat components, in particular seat surface, backrest, head support and/or lumbar support for a plurality of adjusting directions, and also comprising a plurality of memory buttons for calling up or generating individually adjusted seat positions and/or seat parameters. The entire operator control element can be accommodated in a dashboard or in a center console of a motor vehicle.

In this case, the memory buttons are arranged directly around the seat adjusting switch. The seat adjusting switch can be a round switch and the memory buttons can be arranged as a concentric, segmented ring around the seat adjusting switch. Whereas the other seat adjusting operations are performed by corresponding operation of the seat adjusting switches which are constructed from miniaturized seat elements, the lordosis adjusting switch and the memory buttons are arranged in one assembly separately from said seat adjusting switches. The associated lordosis setting is also included when storing seat settings in a memory.

For the purpose of further increasing driving comfort in motor vehicles, it has been proposed to equip vehicle seats with means for performing a massage, in particular a massage in the lumbar region. These means can also be electrically actuated, as a result of which the complexity of arrangements of operator control elements for actuating the electric drives of the vehicle seat is further increased.

For example, U.S. Pat. No. 9,630,533 B2 describes a switch unit for selecting and adjusting seat-related functions of motor vehicle seats. The motor vehicle seat has a seat inflation system for selectively inflating/emptying a large number of inflatable cushions in the seat backrest, in particular in the lumbar region, and/or the seat. The switch unit for controlling the seat inflation system comprises a display with a first symbol, which indicates a function of the cushion in question, and a second symbol, which indicates a parameter of the active function, and also a large number of keypads, which define a circular periphery around the display and can be operated in order to select the active function, and a ring, which surrounds the periphery and can be turned in order to adjust a value of the parameter. Adjustable parameters in relation to a lumbar massage function by the inflatable cushions in the lumbar region are, for example, intensity, speed, active seat, massage pattern and duration. The switching unit can be arranged on the center console, on the seat, for example in the vicinity of an armrest, or in the vicinity of the seat and also in the rear compartment of vehicles in which there is generally little space for switches. The switch can also be arranged in the region of the doors.

WO 01/40012 A2 proposes a vehicle seat arrangement comprising a large number of air cells, which vehicle seat arrangement is provided for supporting a user and/or for massaging said user by changing the pressure in the air cells. The vehicle seat arrangement has a large number of air cells with expandable chambers in a fixed arrangement, a control arrangement for connecting the large number of air cells, and a fluid supply system which contains devices for cutting off one or more of the air cells from the control arrangement in order to match the fixed arrangement of air cells to one type from amongst a plurality of vehicle types. In particular, air cushions are provided in a lumbar region of a backrest of the vehicle seat. Either a single pressure switch with a switchover function, a rocker button with two positions or a combination of two switches for individually controlling air cells are provided for switching on the massage function. A rocker button with two positions is provided for adjusting massage intensity.

U.S. Pat. No. 7,172,247 B2 further proposes that a motor vehicle seat system, a control arrangement, an operating apparatus and a method are used in order to control a lordosis supporting apparatus of a motor vehicle seat. The lordosis adjusting apparatus has a first drive for adjustment in a first adjusting direction, and a second drive for adjustment in a second adjusting direction. The adjusting directions differ from one another. A first setting position is ascertained in the first adjusting direction and the drive movement of the second drive is controlled depending on at least one of either the first setting position or a change in the first setting position with respect to time. A particularly simple embodiment of the operating apparatus has only one operator control element B in which the possible adjustments “upward”, “downward”, “into” and “out of” of the lordosis supporting apparatus and the operator control functions for a massage pattern MF are integrated. In order to select a massage pattern MF, the operator control element B is pushed, wherein the operator control element B serves as a button for making this selection. With each selection made, a preprogrammed massage pattern MF can be selected, symbolized by corresponding schematic illustrations Sym1, Sym2 and Sym3. Correct operation of the operating apparatus for selecting a desired massage pattern therefore requires optical monitoring by the user. In another embodiment of the operating apparatus, parameters of a desired massage pattern MF can be adjusted and programmed by operating a plurality of switches, wherein the adjustment values are digitally displayed and have to be visually monitored before programming.

Furthermore, U.S. Pat. No. 8,471,158 B2 describes an electrically driven motor vehicle seat with a backrest and a head support, each of which is controlled by one or more buttons on an electrically operated switch arrangement. The switch arrangement is arranged on a seat flank of the motor vehicle seat and facilitates, amongst other things, upward/downward and forward/backward movements of the seat, turning of the backrest, lumbar adjustment of the backrest and tilting movements of the head support. A lumbar operator control knob is used in order to provide four-way adjustment of a lordosis support of the backrest, and a rocker button is used in order to adjust the width of the backrest. A series of angled rocker buttons can be used for other features such as massage and memory functions. The large number of nine operator control knobs and buttons of the switch arrangement are arranged in the immediate vicinity of one another and arranged in a manner enclosed in a sheathing or an outer housing which is dimensioned and configured such that it can be fitted to the outside of the seat.

In respect of an alternative approach, the specialist article written by P. S. Sandhu, “Automatic Seat Adjustment”, International Journal of Engineering Research and Technology, ISSN 0974-3154, Volume 6, Number 5 (2013), S. 631-634, reports on a design of an automatic seat adjusting apparatus which has been developed in order to eliminate a waste of time and mental stress experienced by person when adjusting the seat or chair to be as comfortable as possible by applying the principles of automation and ergonomics technology. The objective of the design is to eliminate the steps for adjusting the seat using various buttons. Instead of pushing switches and levers and holding them for a relatively long time, the user of the seat can be assisted in the task in a simple manner by simply inputting his/her height. If the seat is still found to be uncomfortable after having been automatically adjusted, the person can manually adjust the seat by using the electric seat adjusting buttons. These adjustments comprise the forward/backward movement, the seat height raising/lowering operations, the inclination adjustment and the head support adjustment. As soon as these adjustments have been manually made, the user can store the settings by pushing the “Store/retrieve” button for three seconds. When this is done, the seat position is stored in the memory unit of the microcontroller.

Individually programmable buttons or pairs of buttons are known from the prior art, for example from http://descargas.futurasmus-knxgroup.org/DOC/GB/Merten/1482/P6242xx GB.pdf.

In view of the presented prior art, there is still room for improvement in the field of actuating electric drives for adjusting movable parts of an electrically adjustable vehicle seat.

### SUMMARY OF THE INVENTION

It is desirable to provide an operator control apparatus for actuating an electrically adjustable lumbar support, which is provided for performing a massage function, of a motor vehicle seat, which operator control apparatus requires as far as possible no installation space within a field of vision of a user of the motor vehicle seat and facilitates as far as possible simple and operationally reliable adjustment of operating parameters of the lumbar support.

It should be noted that the features and measures set out individually in the following description can be combined with one another in any desired, technically expedient manner and present further refinements of the invention.

The operator control unit according to the invention serves to control an electrically adjustable lumbar support of a motor vehicle seat, where the lumbar support is provided for performing a massage function. In this case, a four-way button for setting an inoperative position of the lumbar support and a three-way switching element for selecting a predetermined value for a massage parameter of the lumbar support are provided in the operator control unit.

Owing to the proposed operator control unit, seven different inputs for controlling the electrically adjustable lumbar support can be made in a simple and operationally reliable manner by means of the four-way button and the three-way switching element, said inputs rendering visual monitoring of the input by a user unnecessary. This further allows the operator control unit to be arranged outside a field of vision of the user of the vehicle seat, as a result of which installation space which lies within the field of vision of the user can advantageously be assigned to those operator control functions for which visual monitoring is a critical requirement.

The three-way switching element may be designed as a switch, button or as a combination of switching contacts and touch-operated contacts, as a result of which a high degree of flexibility in respect of design may be achieved.

Within the meaning of this invention, a “motor vehicle” is intended to be understood to mean, in particular, a passenger car, a truck, a tractor or a bus. Within the meaning of the invention, the term “provided for” is intended to be understood to mean, in particular, specially programmed, designed or arranged for this purpose.

The inoperative position of the lumbar support may be set in the direction of a backrest of the motor vehicle seat and parallel to a straight-ahead direction of travel of the motor vehicle. Effective setting of the inoperative position of the lumbar support is rendered possible in this way. If the massage function of the lumbar support is likewise provided in these two directions, the same electric drives can be provided for setting the inoperative position and for performing the massage function of the lumbar support, as a result of which a particularly cost-effective solution can be provided.

In an embodiment, the four-way button is designed as a four-way navigation button with two button axes which are oriented perpendicularly in relation to one another. An operator control unit with particularly simple and intuitive setting of the inoperative position of the lumbar support may be provided in this way.

The massage parameter may be formed by a massage intensity. As a result, three different predetermined values for the massage intensity may be selected in a simple manner by means of the three-way switching element.

If one of the three different predetermined values for the massage intensity corresponds to a massage intensity of zero, a simple switch-on and switch-off function for the massage function of the lumbar support may be provided by means of the three-way switching element.

In an embodiment of the operator control unit, the predetermined value for the massage intensity of zero can be selected by pushing the three-way switching element, which is in a central switching position. Particularly well-defined switch-off of the massage function of the lumbar support, which can be performed in a particularly simple and operationally reliable manner as a result, can be achieved in this way.

In an embodiment of the operator control unit, the four-way button and the three-way switching element may be arranged next to one another on a side flank of a motor vehicle seat. As a result, the operator control unit may be arranged such that it can be easily reached by a seat user and can be operated in a particularly intuitive manner in a suitable configuration.

This is the case particularly when the three switching positions of the three-way switching element are arranged in the vertical direction. In this case, the three-way switching element may be particularly easily felt and operated by a seat user without visual monitoring.

In an arrangement of this kind, the predetermined value for the massage parameter that is selected in an upper switching position of the three-way switching element is preferably greater than the predetermined value for the massage parameter that is selected in a lower switching position of the three-way switching element. On account of a direct imaginary association between a high value of the massage parameter and an upper switching position, a particularly intuitive way of selecting the massage parameter can be provided for the seat user.

A further aspect of the invention proposes a motor vehicle seat which has an electrically adjustable and operable lumbar support, a drive unit for electrically adjusting the lumbar support and a drive unit for electrically adjusting the lumbar support and one embodiment of the proposed operator control unit which is connected, for control purposes, to the drive unit for controlling the lumbar support.

The advantages described in conjunction with the various embodiments of the proposed operator control unit can be applied in full to a motor vehicle seat of this kind.

### BRIEF DESCRIPTION OF THE DRAWINGS

Further advantageous refinements of the invention are disclosed in the claims and the following description of the figures, in which:

FIG. 1 shows a schematic, perspective illustration of a motor vehicle seat comprising an operator control unit for controlling an electrically adjustable lumbar support,

FIG. 2 shows a schematic elevation view of the operator control unit, and

FIGS. 3-7 show schematic illustrations of alternative operator control units in the same view as FIG. 2, but with FIG. 7 showing a perspective view.

### DETAILED DESCRIPTION

In the various figures, identical parts are always provided with the same reference symbols, and therefore said parts are generally described only once.

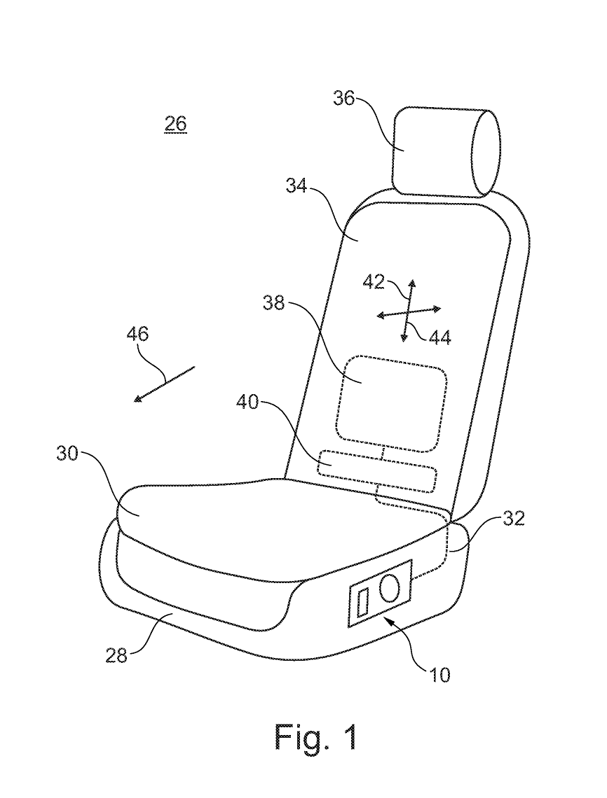

FIG. 1 shows a schematic, perspective illustration of a motor vehicle seat 26, which is provided for use as a driver's seat in a left-hand drive motor vehicle, for example of a passenger car. The vehicle seat 26 has, in a manner which is known per se, a seat base 28, which can be displaced along a straight-ahead direction 46 (see direction arrow) of travel, for supporting a seat user at the bottom, a seat cushion 30 which is arranged on the seat base 28, a panel 32 which covers the seat base 28 and a portion of the seat cushion 30 in a partially surrounded manner on the door side and is composed of a plastic material, a pivotably mounted backrest 34 for supporting a back of the seat user, and a head support 36.

The seat base 28 and the backrest 34 can be adjusted by separate electric drives and by operating appropriate switching elements, not illustrated, in a manner which is known in the art.

The motor vehicle seat 26 further has an electrically adjustable and operable lumbar support 38 (lordosis support). The lumbar support 38 is integrated in the backrest 34 and is designed such that it can be adjusted in a direction 42 (see direction arrow) parallel to a center line of the backrest 34 (i.e., generally vertical) and also in a direction 44 (see direction arrow) perpendicular to the backrest 34 (i.e., generally horizontal) of the motor vehicle seat 26. The lumbar support 38 is provided for performing a massage function. Possible embodiments of lumbar supports of this kind are known to a person skilled in the art and therefore are not described in any detail herein.

For the purpose of electrically adjusting the lumbar support 38, the motor vehicle seat 26 is equipped with a drive unit 40 which includes one or more electric motors and a suitable drive electronics system, which may be conventional. On the door-side flank of the motor vehicle seat 26, the motor vehicle seat 26 has an operator control unit 10 for controlling the electrically adjustable lumbar support 38 integrated in the panel 32. To this end, the operator control unit 10 is connected, for control purposes, to the drive unit 40.

The switching elements for adjusting the seat base 28 and the backrest 34 are arranged at such a distance from the operator control unit 10 that inadvertent confusion between them is precluded.

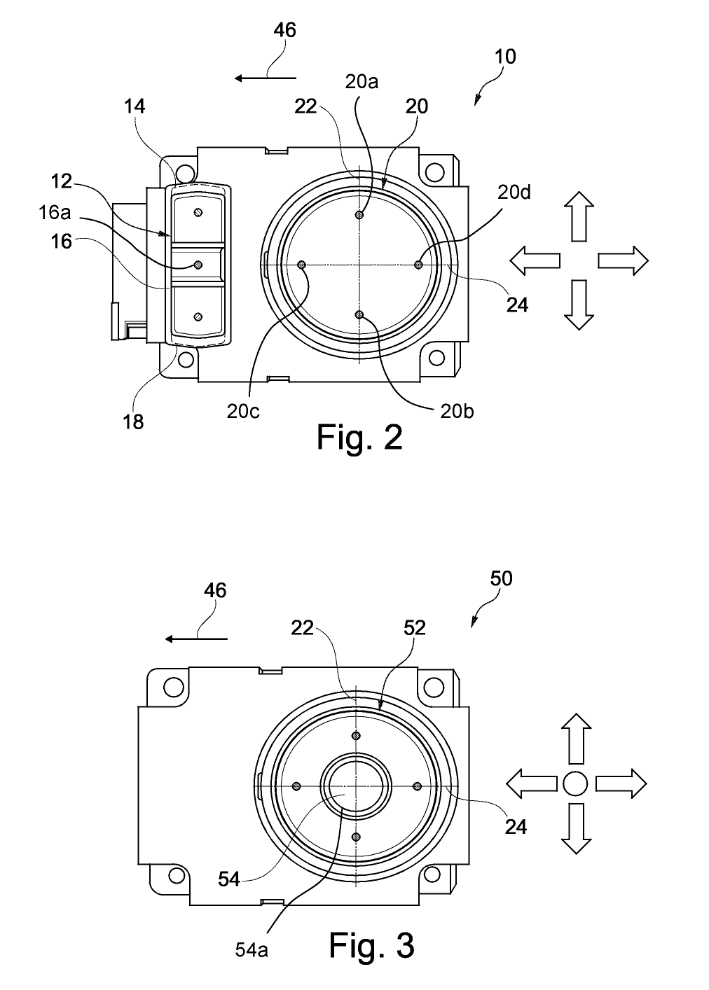

FIG. 2 shows a schematic elevation view of the operator control unit 10 according to FIG. 1. A three-way switching element 12 and a four-way button 20 are arranged next to one another in the operator control unit 10, where the three-way switching element 12 is arranged in front of the four-way button 20 as seen in the straight-ahead direction 46 of travel. Alternatively, the three-way switching element 12 may also be arranged behind the four-way button 20 as seen in the straight-ahead direction 46 of travel.

The four-way button 20 is configured as a four-way navigation button with two button axes 22, 24 which are oriented perpendicularly in relation to one another, where one button axis 22 is arranged in the vertical direction and the other button axis 24 is arranged parallel in relation to the straight-ahead direction 46 of travel (i.e., generally horizontal). The four-way button 20 is provided for setting an inoperative position of the lumbar support 38.

Each of the four buttons of the four-way button 20 is arranged on a common surface in a position by way of which a direction of action of a movement that is triggered by means of the drive unit 40 by pushing the respective button is specified. The movement is stopped when pressing on the respective button is discontinued. Continued pressing on the upper button 20a of the four switches shifts the lumbar support 38 upward. Continued pressing on the lower button 20b of the four buttons shifts the lumbar support 38 downward. Continued pressing on the left-hand-side (i.e., forward) button 20c of the four buttons shifts the lumbar support 38 forward, that is to say in the direction of the straight-ahead direction 46 of travel. Continued pressing on the right-hand-side (i.e., rearward) button 20d of the four buttons shifts the lumbar support 38 backward, that is to say opposite the straight-ahead direction 46 of travel. Although the four-way button 20 is arranged outside the field of vision of the seat user, the appropriate button for the direction of desired movement of the lumbar support 38 can be selected without visual monitoring.

The four buttons of the four-way button 20 can be formed, for example, by programmable buttons in the case of which pressing the button triggers transmission of a digital data signal by way of which one of the electric motors of the drive unit 40 can be addressed. Programmable buttons of this kind are known in the prior art and are available.

The three-way switching element 12 has three switching positions 14, 16, 18 which are arranged in the vertical direction. The three-way switching element 12 is equipped with a switching element in an upper switching position 14 and in a lower switching position 18. In a central switching position 16, the three-way switching element 12 is equipped with an unlatched touch-operated element with a pushbutton function. FIG. 2 shows the three-way switching element 12 in the central switching position 16.

The three-way switching element 12 is provided for selecting a predetermined value for a massage parameter of the lumbar support 38. In this specific embodiment, the massage parameter is formed by a massage intensity which is characterized, for example, by pre-specified amplitudes of a periodic movement of the lumbar support 38 in the direction 42 parallel in relation to the center line of the backrest 34 and/or in the direction 44 perpendicular in relation to the backrest 34. Alternatively, the massage parameter can be formed by a frequency of a periodic massage movement or a massage pattern, that is to say a pre-specified time profile of a massage amplitude.

When the three-way switching element 12 is moved to the upper switching position 14, an electrical connection is established within the drive unit 40 by the switch element located in said upper switching position, by way of which electrical connection a predetermined value for the massage intensity is selected. When the three-way switching element 12 is moved to the lower switching position 18, an electrical connection is established within the drive unit 40 by the switch element located in said lower switching position, by way of which electrical connection a further predetermined value for the massage intensity is selected, which further predetermined value is smaller than the predetermined value selected in the upper switching position 14.

When the three-way switching element 12 is moved to the central position 16, an electrical connection is established within the drive unit 40 by pressing on the non-latched touch-operated element 16a located in said central position in one position of the touch-operated element, so that a predetermined value of zero is selected for the massage intensity. Given this selection, the massage intensity remains at a value of zero even if the three-way switching element 12 is subsequently moved to the upper switching position 14 or to the lower switching position 18. The electrical connection within the drive unit 40 is re-established by once again pressing on the non-latched touch-operated element in the central switching position 16 of the three-way switching element 12, so that a massage intensity not equal to zero is possible by moving the three-way valve switching element 12 to the upper switching position 14 or to the lower switching position 18.

Alternatively, the three-way switching element 12 can be equipped with a unlatched touch-operated element in the upper switching position 14 and in a lower switching position 18, so that the high predetermined value for the massage intensity is selected by moving the three-way switching element 12 to the upper switching position 14 and the low predetermined value for the massage intensity is selected by moving the three-way switching element 12 to the lower switching position 18, where the three-way switching element 12 automatically assumes the central switching position 16 again owing to spring force biasing the element 12 toward the central position 16 after being moved to the upper switching position 14 or to the lower switching position 18.

Alternative embodiments of the operator control unit will be described below. In order to avoid repetition, only the differences from the above embodiment of the operator control unit 10 according to FIG. 2 will be described in the text which follows.

In the embodiment of the operator control unit 50 according to FIG. 3 (in view of FIG. 1), a three-way switching element 54 is integrated in a four-way button 52 which is designed as a four-way navigation button with two button axes 22, 24 which are oriented perpendicularly in relation to one another. The three-way switching element 54 is formed by an unlatched pushbutton 54a, which is arranged in a cutout in the center of the four-way button 52. Predetermined values for a massage parameter of the lumbar support 38, which massage parameter is designed as a massage intensity, are selected in succession by successively operating the pushbutton. The predetermined values for the massage intensity corresponds to a low intensity, a high intensity and an intensity of zero, where this order is cyclically continued with further operation of the pushbutton.

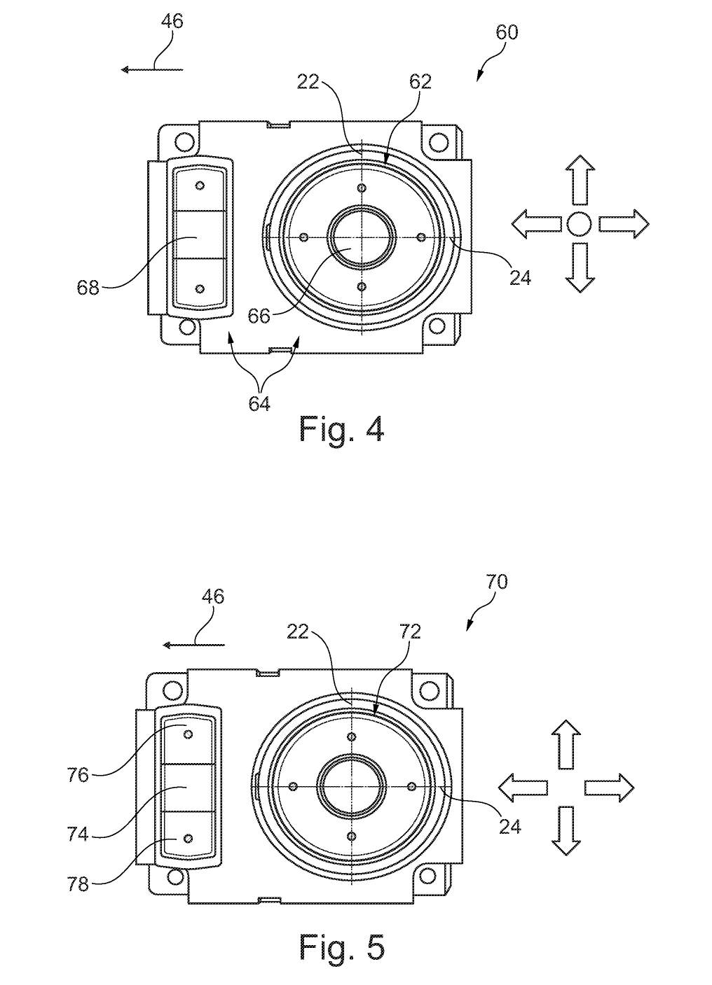

In the embodiment of the operator control unit 60 according to FIG. 4 (in view of FIG. 1), a switching element 66 of a three-way switching element 64 is integrated in a four-way button 62 which is designed as a four-way navigation button with two button axes 22, 24 which are oriented perpendicularly in relation to one another. The integrated switching element 66, which is arranged in a cutout in the center of the four-way button 62, is designed as a switch or button. The two other switching elements of the three-way switching element 64 are arranged in a vertical direction in a rocker switch 68 or, as an alternative, in a rocker button which is located in front of the four-way button 62 in the straight-ahead direction 46 of travel. By operating the integrated switching element 66, a massage intensity of zero can be selected in a first switching position. By operating the integrated switching element 66 again, a massage intensity which is determined by the position of the rocker switch 68 or rocker button of the three-way switching element 64 can be set in a second switching position

In the embodiment of the operator control unit 70 according to FIG. 5 (in view of FIG. 1), a four-way button 72 is designed as a four-way navigation button with two button axes 22, 24 which are oriented perpendicularly in relation to one another. A three-way switching element 74 is designed as a rocker button. A high predetermined value for a massage intensity is selected by moving the rocker button to an upper switching position 76. A low predetermined value for a massage intensity is selected by moving the rocker button to a lower switching position 78. A predetermined value of zero for the massage intensity is selected by moving the rocker button twice in succession to one of the switching positions 76, 78.

As an alternative, the three-way switching element 74 in the operator control unit 70 according to FIG. 5 can be designed as a rocker button with two integrated switching positions. By operating an unlatched touch-operated element of the rocker button, a predetermined value of zero for the massage intensity can be selected in one switching position of the touch-operated element. By operating the unlatched touch-operated element of the rocker button again, a predetermined value for a massage intensity which is determined by one of the two integrated, latched switching positions of the three-way switching element can be set in a second switching position.

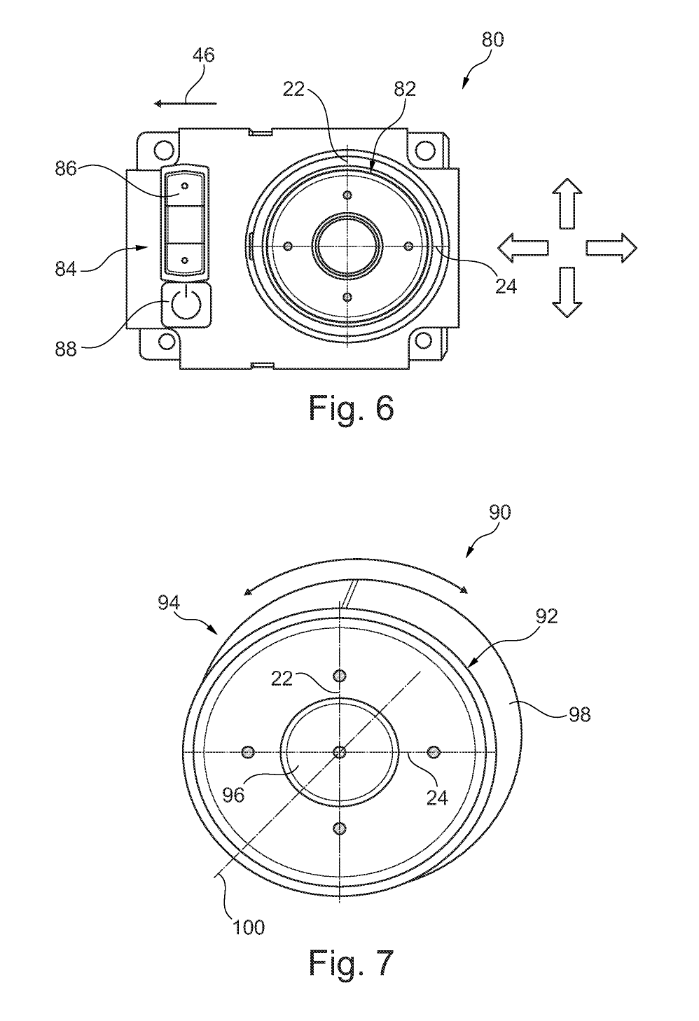

In the embodiment of the operator control unit 80 according to FIG. 6 (in view of FIG. 1), a four-way button 82 is designed as a four-way navigation button with two button axes 22, 24 which are oriented perpendicularly in relation to one another. A three-way switching element 84 is formed by a rocker switch 86 with two latched switching positions and a pushbutton 88. A predetermined value of zero for the massage intensity is selected by moving the pushbutton 88 to a first switching position. A predetermined value for the massage intensity which is determined by one of the two switching positions of the rocker switch 86 of the three-way switching element 84 is selected by moving the pushbutton 88 to a second switching position.

In the embodiment of the operator control unit 90 according to FIG. 7 (in view of FIG. 1), a four-way button 92 and a three-way switching element 94 are formed in an integrated manner. The four-way button 92 is designed as a four-way navigation button with two button axes 22, 24 which are oriented perpendicularly in relation to one another. An integrated switching element 96 of the three-way switching element 94, which switching element 96 is arranged in a cutout in the center of the four-way button 92, is designed as a switch or button. The three-way switching element 94 further has a rotary wheel 98 which is designed such that it can rotate about a rotation axis 100, which is arranged perpendicularly in relation to a surface of the four-way button 92, and has two latched switching positions, a high value and a lower value for a massage intensity respectively being allocated to said switching positions.

By operating the switching element 96 of the three-way switching element 94, which switching element 96 is integrated in the four-way button 92, a predetermined value of zero for the massage intensity is selected in one switching position. By operating the integrated switching element 96 again, a predetermined value for a massage intensity which is determined by one of the two latched switching positions of the rotary wheel 98 can be set in a second switching position.

Alternatively, the rotary wheel 98 may be equipped with two unlatched switching positions in button function. After the integrated switching element 96 is operated, either a predetermined high value or a predetermined lower value for a massage intensity can be selected by moving the rotary wheel 98 to one of the two unlatched switching positions, where the rotary wheel 98 again automatically assumes a central position, as illustrated in FIG. 7, owing to spring force biasing the wheel 98 to the central position after being moved to one of the two unlatched switching positions.

Of course, the invention can also be used for motor vehicle seats in right-hand-drive motor vehicles.

While certain embodiments of the present invention have been described in detail, those familiar with the art to which this invention relates will recognize various alternative designs and embodiments for practicing the invention as defined by the following claims.

1. A vehicle seat comprising:
an electrically adjustable lumbar support configured to perform a massage function; and
an operator control unit controlling the lumbar support, the operator control unit including a four-way button configured to set an inoperative position of the lumbar support, and a three-way switching element configured to select a predetermined value for a massage parameter of the lumbar support.

2. The vehicle seat of claim 1 wherein the four-way button is a four-way navigation button with two button axes, which are oriented perpendicularly in relation to one another.

3. The vehicle seat of claim 2 wherein the four-way button and the three-way switching element are arranged next to one another on a side flank of the vehicle seat.

4. The vehicle seat of claim 1 wherein the massage parameter is a massage intensity.

5. The vehicle seat of claim 4 wherein one of the predetermined values for the massage intensity corresponds to a massage intensity of zero.

6. The vehicle seat of claim 5 wherein the predetermined value for the massage intensity of zero is selected by pushing-in the three-way switching element, which is in a central switching position.

7. The vehicle seat of claim 1 wherein the four-way button and the three-way switching element are arranged next to one another on a side flank of the vehicle seat.

8. The vehicle seat of claim 7 wherein three switching positions of the three-way switching element are arranged in a vertical direction.

9. The vehicle seat of claim 8 wherein the predetermined value for the massage parameter that is selected in an upper switching position of the three-way switching element is greater than the predetermined value for the massage parameter that is selected in a lower switching position of the three-way switching element.

10. The vehicle seat of claim 1 wherein three switching positions of the three-way switching element are arranged in a vertical direction.

11. The vehicle seat of claim 10 wherein the predetermined value for the massage parameter that is selected in an upper switching position of the three-way switching element is greater than the predetermined value for the massage parameter that is selected in a lower switching position of the three-way switching element.

12. A vehicle seat comprising:
an electrically adjustable and operable lumber support;
a drive unit electrically adjusting the lumbar support; and
an operator control unit including a four-way button configured to set an inoperative position of the lumbar support, and a three-way switching element configured to select a predetermined value for a massage parameter of the lumbar support.

13. The vehicle seat of claim 12 wherein the four-way button is a four-way navigation button with two button axes, which are oriented perpendicularly in relation to one another.

14. The vehicle seat of claim 12 wherein the four-way button and the three-way switching element are arranged next to one another on a side flank of the vehicle seat.

15. The vehicle seat of claim 12 wherein three switching positions of the three-way switching element are arranged in a vertical direction.

16. The vehicle seat of claim 15 wherein the predetermined value for the massage parameter that is selected in an upper switching position of the three-way switching element is greater than the predetermined value for the massage parameter that is selected in a lower switching position of the three-way switching element.
